(19) United States
(12) Patent Application Publication
(10) Pub. No.: US 2026/0222924 A1
(43) Pub. Date: Jul. 30, 2026

(54) DEVICES, METHODS AND MEDIUMS FOR COMMUNICATIONS

(71) Applicant: LENOVO (BEIJNG) LIMITED, Beijing (CN)

(72) Inventors: Shuigen Yang, Shanghai (CN); Congchi Zhang, Shanghai (CN); Mingzeng Dai, Shanghai (CN); Bingchao Liu, Beijing (CN); Lianhai Wu, Beijing (CN); Le Yan, Shanghai (CN)

(73) Assignee: LENOVO (BEIJNG) LIMITED, Beijing (CN)

(21) Appl. No.: 19/148,269

(22) PCT Filed: Apr. 7, 2023
(86) PCT No.: PCT/CN2023/087150

§ 371 Date: Jul. 15, 2025

(51) Int. Cl. H04W 36/00

(52) U.S. Cl. CPC H04W 36/0058; H04W 36/0072

(57) ABSTRACT

Embodiments of the present disclosure relate to devices and methods for supporting layer 1 measurement-based layer 1 or layer 2 triggered mobility. A first network device obtains a channel state information (CSI) resource set associated with one or more candidate cells for at least one Layer 1 (L1) measurement, wherein the CSI resource set is to be used by a terminal device to perform the at least one L1 measurement; and transmit, via the transceiver to a second network device serving the terminal device, information indicative of the CSI resource set. In this way, the L1 measurement report may not support the L1 measurement-based LTM.

### FIELD

Embodiments of the present disclosure generally relate to the field of communication, and in particular to network devices, a terminal device, methods, and non-transitory computer readable mediums for communication.

### BACKGROUND

When a user equipment (UE) moves from one cell to another cell, at some point a serving cell change needs to be performed. In the legacy, the serving cell change is done by explicit radio resource control (RRC) reconfiguration signaling to trigger the synchronization of target cell based on L3 measurements report. It leads to longer latency, larger overhead, and longer interruption time than beam level mobility. Therefore, in 3GPP Release 18, a new work item on further new radio (NR) mobility enhancements, named as layer 1 (L1)/layer 2 (L2)-triggered mobility (LTM), was approved to enable a serving cell change via L1/L2 signaling, in order to reduce the latency, overhead and interruption time.

However, the legacy L1 measurement reporting, e.g., synchronization signal/physical broadcast channel block (SSB) based measurement or channel state information reference signal (CSI-RS) based measurement, may not support the LTM. Therefore, there is a need for a solution for supporting the L1 measurement for LTM.

### SUMMARY

In general, embodiments of the present disclosure provide a solution for communications, especially, for supporting L1 measurement-based LTM.

In a first aspect, there is provided a first network device. The first network device comprises a processor and a transceiver coupled to the processor. The processor is configured to: obtain a channel state information (CSI) resource set associated with one or more candidate cells for at least one L1 measurement, wherein the CSI resource set is to be used by a terminal device to perform the at least one L1 measurement; and transmit, via the transceiver to a second network device serving the terminal device, information indicative of the CSI resource set.

In a second aspect, there is provided a second network device. The second network device comprises a processor and a transceiver coupled to the processor. The processor is configured to: obtain a CSI resource set associated with one or more candidate cells for at least one L1 measurement, wherein the CSI resource set is to be used by a terminal device to perform the at least one L1 measurement; transmit, to the terminal device, information indicative of the CSI resource set; and obtain at least one L1 measurement report.

In a third aspect, there is provided a terminal device. The terminal device comprises a processor and a transceiver coupled to the processor. The processor is configured to: receive, from a second network device serving the terminal device, information indicative of a CSI resource set associated with one or more candidate cells for at least one L1 measurement; perform the at least one L1 measurement for the CSI resource set; and transmit at least one L1 measurement report.

In a fourth aspect, there is provided a method performed by a first network device. The method comprises: obtaining a CSI resource set associated with one or more candidate cells for at least one L1 measurement, wherein the CSI resource set is to be used by a terminal device to perform the at least one L1 measurement; and transmitting, via the transceiver to a second network device serving the terminal device, information indicative of the CSI resource set.

In a fifth aspect, there is provided a method performed by a second network device. The method comprises: obtaining a CSI resource set associated with one or more candidate cells for at least one L1 measurement, wherein the CSI resource set is to be used by a terminal device to perform the at least one L1 measurement; transmitting, to the terminal device, information indicative of the CSI resource set; and obtaining at least one L1 measurement report.

In a sixth aspect, there is provided a method performed by a terminal network device. The method comprises: receiving, from a second network device serving the terminal device, information indicative of a CSI resource set associated with one or more candidate cells for at least one L1 measurement; performing the at least one L1 measurement for the CSI resource set; and transmitting at least one L1 measurement report.

In a seventh aspect, there is provided a non-transitory computer readable medium. The non-transitory computer readable medium having program instructions stored thereon. The program instructions, when executed by an apparatus, causing the apparatus at least to: obtain a CSI resource set associated with one or more candidate cells for at least one L1 measurement, wherein the CSI resource set is to be used by a terminal device to perform the at least one L1 measurement; and transmit, via the transceiver to a second network device serving the terminal device, information indicative of the CSI resource set.

In an eighth aspect, there is provided a non-transitory computer readable medium. The non-transitory computer readable medium having program instructions stored thereon. The program instructions, when executed by an apparatus, causing the apparatus at least to: obtain a CSI resource set associated with one or more candidate cells for at least one L1 measurement, wherein the CSI resource set is to be used by a terminal device to perform the at least one L1 measurement; transmit, to the terminal device, information indicative of the CSI resource set; and obtain at least one L1 measurement report.

In a ninth aspect, there is provided a non-transitory computer readable medium. The non-transitory computer readable medium having program instructions stored thereon. The program instructions, when executed by an apparatus, causing the apparatus at least to: receive, from a second network device serving the terminal device, information indicative of a CSI resource set associated with one or more candidate cells for at least one L1 measurement; perform the at least one L1 measurement for the CSI resource set; and transmit at least one L1 measurement report.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1A illustrates a schematic diagram of a communication environment in which intra-distributed unit (DU) lower layer mobility can be implemented;

FIG. 1B illustrates a schematic diagram of a communication environment in which intra-central unit (CU) inter-DU lower layer mobility can be implemented;

FIG. 1C illustrates a schematic diagram of a communication environment in which some embodiments of the present disclosure can be implemented;

FIG. 2A illustrates a signaling chart illustrating communication process in accordance with some example embodiments of the present disclosure;

FIG. 2B illustrates an example CSI resource configuration in accordance with some example embodiments of the present disclosure;

FIG. 3 illustrates a message flow of a communication process in accordance with some example embodiments of the present disclosure;

FIG. 4A illustrates a further message flow of a communication process in accordance with some example embodiments of the present disclosure;

FIG. 4B illustrates an example CSI resource configuration in accordance with some example embodiments of the present disclosure;

FIG. 4C illustrates an example CSI resource configuration in accordance with some example embodiments of the present disclosure;

FIG. 5A illustrates a still message flow of a communication process in accordance with some example embodiments of the present disclosure;

FIG. 5B illustrates an example CSI-Meas configuration in accordance with some example embodiments of the present disclosure;

FIG. 6 illustrates a still further message flow of a communication process in accordance with some example embodiments of the present disclosure;

FIG. 7 illustrates a flowchart of an example method implemented at a center unit or a first network device in accordance with some embodiments of the present disclosure;

FIG. 8 illustrates a flowchart of an example method implemented at a source unit or a second network device in accordance with some embodiments of the present disclosure;

FIG. 9 illustrates a flowchart of an example method implemented at a terminal device in accordance with some embodiments of the present disclosure; and

FIG. 10 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “some embodiments,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, fifth generation (5G) NR, long term evolution (LTE), LTE-advanced (LTE-A), wideband code division multiple access (WCDMA), high-speed packet access (HSPA), narrow band internet of things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, 5G communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a remote radio unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an internet of things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term: “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

As mentioned above, when the UE moves from one cell to another cell, at some point a serving cell change needs to be performed. In the legacy, the serving cell change is done by explicit RRC reconfiguration signaling to trigger the synchronization of target cell based on L3 measurements report. It leads to longer latency, larger overhead, and longer interruption time than beam level mobility.

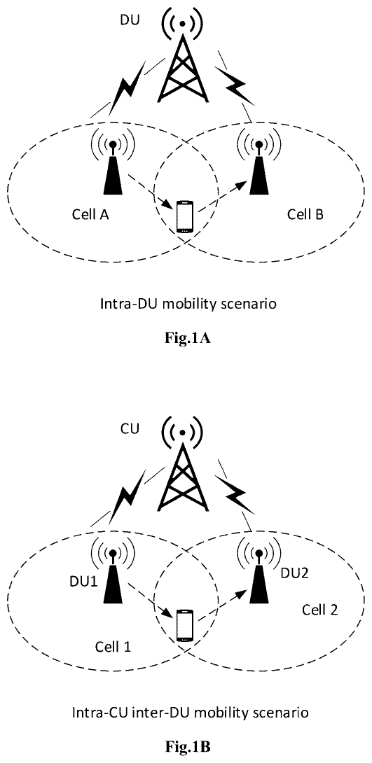

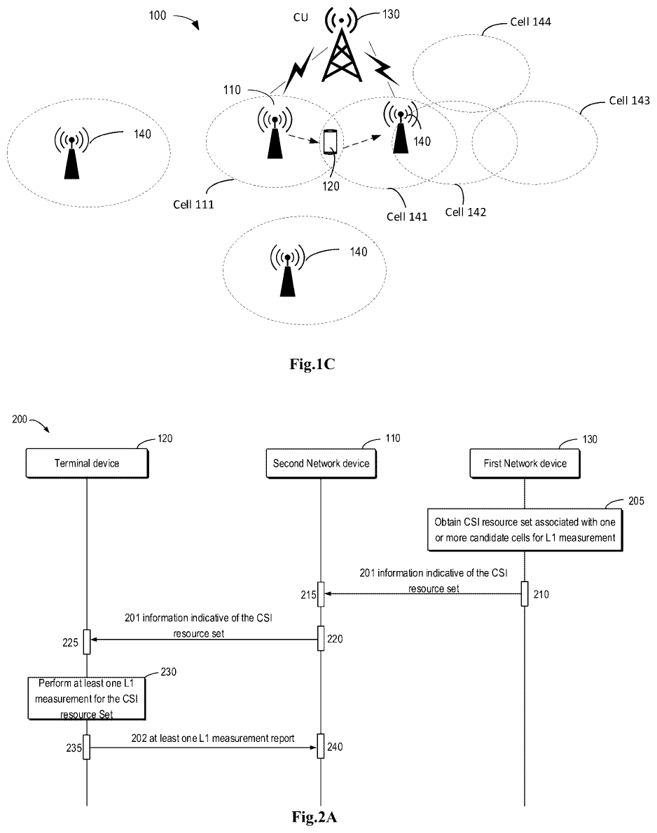

Therefore, in 3GPP Release 18, a new work item on further NR mobility enhancements, named as LTM, was approved to enable a serving cell change via L1/L2 signaling, in order to reduce the latency, overhead and interruption time. The potential applicable scenarios of LTM include intra-CU intra-DU mobility as shown in FIG. 1A and intra-CU inter-DU mobility and as shown in FIG. 1B.

As for intra-CU intra-DU mobility scenario, as shown in FIG. 1A, UE moves between different cells within a same DU. In short, this scenario is called as intra-DU mobility. In this scenario, the UE moves in the cells belonging to a same DU, and the DU is able to know the target cells within the candidate cells managed by the DU through the indexes of the candidate cells. For this scenario, the candidate cells, such as cell A and cell B are provided by the DU. With LTM, the UE obtains the multiple candidate cell (such as, cell A and cell B) configurations before the cell switch via RRC reconfiguration. Based on the L1 measurement reports from the UE, the source DU selects one of the candidate cells (such as, cell A and cell B) as target cell and triggers the LTM cell switch by sending index of the candidate cell configuration to the UE via medium access control-control element (MAC CE). Each index is used to identify a candidate cell configuration for the UE. From the UE perspective, an index indicates which candidate cell configuration should be applied/used/activated by the UE when the UE receives the LTM cell switch command (e.g., MAC CE).

However, in the scenario, as shown in FIG. 1B when the UE moves between different cells belonging to different DUs within a same CU. In short, this scenario is called as inter-DU mobility. As shown in FIG. 1B, cell 1 belongs to DU1 which is a source DU, and cell 2 belongs to DU2, which is a candidate DU, and the UE moves from cell 1 to cell 2, and the DU1 and DU2 are both within a same CU.

In this scenario, when receiving L1 measurement report from UE, the source DU1 may not know the target cell (for example, cell 2) by the index of the cell 2, since cell 2 belongs to another DU2. Therefore, in this scenario, the L1 measurement report may not support the L1 measurement-based LTM.

In view of the above discussions, embodiments of the present disclosure provide a solution for supporting the L1 measurement-based LTM. In one aspect of the solution of the present disclosure, a first network device obtains a CSI resource set associated with one or more candidate cells for at least one L1 measurement, wherein the CSI resource set is to be used by a terminal device to perform the at least one L1 measurement; and transmit, via the transceiver to a second network device serving the terminal device, information indicative of the CSI resource set. Through the proposed solution, the L1 measurement report may support the L1 measurement-based LTM.

Principles and implementations of embodiments of the present disclosure will be described in detail below with reference to the figures.

### Example Communication Environment

FIG. 1C illustrates a schematic diagram of a communication environment 100 in which some embodiments of the present disclosure can be implemented. As shown in FIG. 1C, the communication environment 100, which may also be referred to as a communication network 100 or a communication system 100, includes a CU 130 (which is sometimes also referred to as a first network device), a serving or source DU 110 (which is sometimes also referred to as a second network device), and a plurality of candidate DUs 140 (which are sometimes also referred to as third network devices), and a terminal device 120. A gNB or a network device may comprise a CU and a DU, and the segmentation of CU and DU is carried out according to the real-time requirements of different protocol layers. Under this principle, the physical high layer, medium access control, and radio link control (RLC) layers that require high real-time performance are placed in the DU for processing, and the packet data convergence protocol (PDCP) and RRC layers that do not require high real-time performance are placed in the CU for processing. The candidate DU 140 may manage a plurality of cells, for example, cells 141 to 144, and it should be noted that the number of the candidate cells is just for the purpose of illustration. The source DU 110 also manages a plurality of cells and serves the terminal device 120; however, as shown in FIG. 1C, only one cell 111 among the plurality of cells is shown. To transmit data and/or control information, the terminal device 120 can perform communications with the source DU 110. It should be noted that the candidate cells are within the source DU. That is, the candidate DU and the source DU are the same. For example, the cells 141 to 144 and cell 111 are within the same DU (e.g., source DU), and the candidate DU 140 and the source DU 110 are the same.

In the legacy L1 measurement reporting, for the SSB based measurement, the UE shall report SSB resource indicator (SSBRI), where SSBRI k (k≥0) corresponds to the configured (k+1)-th entry of the associated CSI-SSB-ResourceList in the corresponding CSI-SSB-ResourceSet. For the CSI-RS based measurement, the UE shall report CSI-RS resource indicator (CRI), where CRI k (k≥0) corresponds to the configured (k+1)-th entry of the associated NZP ((Non-Zero-power))-CSI-RS-Resources in the corresponding NZP-CSI-RS-ResourceSet for channel measurement. The L1 measurement report may include multiple instances, where each instance is the pair of <CRI, L1 measurement result> or <SSBRI, L1 measurement result>.

As can be seen, the legacy L1 measurement report comprises the resource indicator. For legacy SSB based measurement obtained from the candidate DU 140, the SSBRI k corresponds to the configured (k+1)-t entry of the SSB ResourceList. That is to say, the indicator only indicates the order of this measurement in the resource list of SSB resource set configured by the candidate DU 140, but may not indicate the specific cell ID of the candidate DU 140. Therefore, based on the legacy L1 measurement report obtained from the candidate DU 140, the source DU 110 may not determine the target cell. That is to say, when the target cell for LTM cell switch is selected by the source DU 110, since the legacy L1 measurement report does not include the cell identity (ID), the source DU 110 does not know how to select the target cell from the candidate cells provided by another DU, rather than the source DU 110. That is, the source DU 110 cannot select the target cell based on the legacy L1 measurement framework, especially for the inter-DU scenario.

Although the network devices 110, 130, and 140 and the terminal devices 120 are described in the communication environment 100 of FIG. 1C, embodiments of the present disclosure may equally apply to any other suitable communication devices in communication with one another. That is, embodiments of the present disclosure are not limited to the exemplary scenarios of FIG. 1C. In this regard, it is noted that although the network devices 110, 130, and 140 are schematically depicted as different parts of a base station and the terminal devices 120 are schematically depicted as mobile phones in FIG. 1C, it is understood that these depictions are exemplary in nature without suggesting any limitation. In other embodiments, the network devices 110, 130, and 140 and the terminal devices 120 may be any other communication devices, for example, any other wireless communication devices.

It is to be understood that the particular number of various communication devices, the particular number of various communication links, the particular number of other elements, and the particular shape of the cells as shown in FIG. 1C is for illustration purpose only without suggesting any limitations. The communication environment 100 may include any suitable number of communication devices, any suitable number of communication links, any suitable number of other elements and any suitable shape of the cells adapted for implementing embodiments of the present disclosure. In addition, it should be appreciated that there may be various wireless as well as wireline communications (if needed) among all of the communication devices.

Communication in the communication environment 100 may be implemented according to any proper communication protocol(s), comprising but not limited to, cellular communication protocols of the first generation (1G), the second generation (2G), the third generation (3G), the fourth generation (4G) and the fifth generation (5G), NR-U and the like, wireless local network communication protocols such as institute for electrical and electronics engineers (IEEE) 802.11 and the like, and/or any other protocols currently known or to be developed in the future. Moreover, such communication may utilize any appropriate wireless communication technology, comprising but not limited to: code division multiple access (CDMA), frequency division multiple access (FDMA), time division multiple access (TDMA), frequency division duplex (FDD), time division duplex (TDD), multiple-input multiple-output (MIMO), orthogonal frequency division multiple (OFDM), discrete fourier transform spread OFDM (DFT-s-OFDM) and/or any other technologies currently known or to be developed in the future.

It is to be understood that the numbers of devices (i.e., the network device 110, 130, and 140 and the terminal device 120) and their connection relationships and types shown in FIG. 1C are for the purpose of illustration without suggesting any limitation. The system 100 may include any suitable numbers of devices adapted for implementing embodiments of the present disclosure.

### Exemplary Signaling Chart

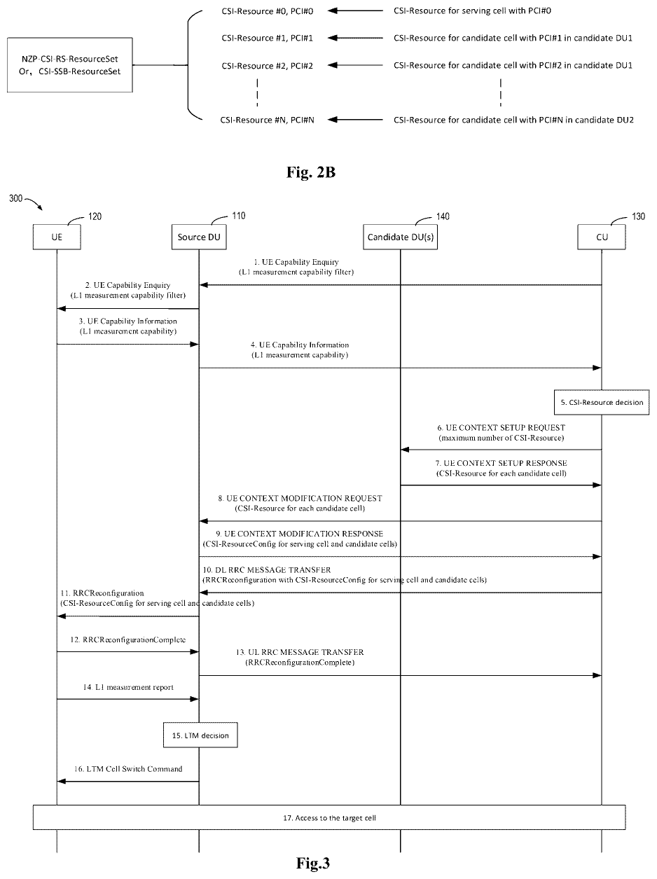

Reference is further made to FIG. 2A, which illustrates a signaling chart illustrating communication process 200 in accordance with some example embodiments of the present disclosure. For the purpose of discussion, the process 200 will be described with reference to FIG. 1C, the process 200 may involve the first network device 130, the second network device 110, and a terminal device 120. Hereinafter the network device 130 may also be referred to as a CU, and the second network device 110 may also be referred to as a source DU 110 for serving the terminal device 120.

The first network device 130 (for example, a CU) obtains 205 a CSI resource set associated with one or more candidate cells for the L1 measurement. The CSI resource set may be obtained from the one or more candidate cells 141 to 144 by receiving the CSI resource set configured by a candidate DU 140 or a plurality of candidate DU 140. Then, the first network device 130 transmits 210, to the second network device 110 (for example, a source DU 110 serving the terminal device 120) information 201 indicative the CSI resource set. Then, the second network device 110 receives 215 the information 201 indicative of the CSI resource set. Although it is shown in FIG. 2 that the second network device 110 receives 215 the information 201 from the first network device 130, it should be appreciated that the second network device 110 can obtain the information 201 in any other suitable manners. For example, the first network device or the CU 130 may transfer the CSI resource obtained from the candidate DU 140 to the second network device or the source DU 110, instead of transmitting the information indicative of the CSI resource to the source DU 110, and then the second network device or the source DU 110 can obtain the CSI resource set associated with the one or more candidate cells.

In some embodiments, the first network device 130 transmits the obtained CSI resource set to the second network device 110, and the network device 110 determines or generalizes a CSI resource configuration set for the CSI resource set associated with the candidate cells 141 to 144 or any other cells from other candidate DU 140.

That is to say, since the CSI resource set is associated with one or more candidate cell, the CSI resource may comprise the identity of each candidate cell. When obtaining the CSI resource set from the CU 130, the source DU 110 obtains the CSI-Resource and the corresponding cell ID of the candidate cell (in short, candidate cell ID) from the CU 130. After that, the source DU 110 generalizes the CSI-ResourceConfig including the CSI-Resource of candidate cells and the corresponding candidate cell ID. The cell ID can be any of the physical cell identity (PCI), cell global identity (CGI) or candidate configuration index, where each index is used to identify a candidate cell configuration.

For CSI resource, it may be NZP-CSI-RS-Resource and CSI-SSB-Resource. For the CSI-ResourceConfig, it may define a group of one or more NZP-CSI-RS-ResourceSet, and/or CSI-SSB-ResourceSet. For NZP-CSI-RS-ResourceSet, it may be NZP-CSI-RS resources, where each NZP-CSI-RS resource is configured to measure by the UE. For CSI-SSB-ResourceSet, it may be used to configure one SSB resource set, including one or more CSI-SSB-ResourceList. Each CSI-SSB-ResourceList includes one or more SSB index.

In the above embodiment, the CSI resource configuration determined by the source DU 110 may be as shown in FIG. 2B. As shown in FIG. 2B, the CSI-resource #0 is the CSI resource for the serving cell (for example, cell 111 with PCI #0), the CSI-resource #1 is the CSI resource for the candidate cell (for example, cell 141 with PCI #1), the CSI-resource #2 is the CSI resource for the candidate cell (for example, cell 142 with PCI #2), and the CSI-resource #3 is the CSI resource for the candidate cell (for example, cell 143 with PCI #3).

In another embodiment, after receiving the CSI resource set from the candidate DUs 140, the first network device 130 generalizes or determines a CSI resource configuration set for the CSI resource set associated with the candidate cells, and then transmits the configuration set to the second network device 110. That is to say, the CU 130 obtains the CSI-Resource and the corresponding candidate cell ID from the candidate DU 140 and generalizes the CSI-ResourceConfig. The CU 130 then sends the CSI-ResourceConfig to the UE 120 with the source DU 110 as a relay, such that the UE 120 may perform L1 measurement for the CSI resource configured in the CSI-ResourceConfig. The CU 130 also sends the CSI-ResourceConfig to the source DU 110 such that when the source DU 110 receives the CSI measurement report from the UE 120, the source DU 110 may know which candidate cell is the specific measurement is associated with.

As shown in FIG. 2A, the second network device 110 transmits 220 information 201 indicative of the CSI resource set to the terminal device 120. In some embodiments, if the CSI resource configuration is determined by the first network device 130 itself, the first network device 130 transits the information 201 directly to the second network device 110 including a generated RRCReconfiguration message (for example, via DL RRC MESSAGE TRANSFER message). The RRCReconfiguration includes the information 201. The source DU 110 then transmits the RRCReconfiguration message to the terminal device 120. Meanwhile, since the second network device 110 needs to know the CSI resource set, DL RRC MESSAGE TRANSFER message may further comprise CSI-resourceConfig for candidate cells to the source DU 110, which will be used by the source DU 110 when determining the target cell.

However, in another embodiment, if the CSI resource configuration set is determined by the source DU 110, the source DU 110 transmits the CSI resource configuration to the CU 130, and then the CU 130 may send a DL RRC MESSAGE TRANSFER message to the source DU 110, which includes a generated RRCReconfiguration message. The RRCReconfiguration message includes the CSI-ResourceConfig for the serving cell (for example cell 111) and one or more candidate cells (for example, cells 141 to 144). Note that, the CU 130 may also send the RRCReconfiguration message to the source DU 110 via other message, e.g., UE CONTEXT MODIFICATION REQUEST message. Then, the source DU 110 transmits 220 information 201 indicative of the CSI resource set, to the terminal device 120, via for example the above RRCReconfigurationmessage. The terminal device 120 receives 225 the information 201.

After receiving the information indicative of the CSI resource set configured for the candidate cells, the terminal device 120 performs 230 at least one L1 measurement for the CSI resource set. After measuring, the terminal device 120 transmits 235 the L1 measurement report to the source DU 110. The source DU 110 receives 240 the L1 measurement report from the terminal device 120. In another example, the terminal device 120 may also transmit the L1 measurement report to the candidate DUs 140, and then the candidate DUs 140 transmit the L1 measurement report to the CU 130, which in turns transmits the L1 measurement report to the source DU 110. After receiving the L1 measurement report, the source DU 110 may select a target cell from the candidate cells.

Therefore, through the process 200, the source DU 110 may obtain the CSI-Resource and the corresponding candidate cell ID for the candidate cells from the CU, and generalizes the CSI-ResourceConfig including the CSI-Resource of candidate cells and the corresponding candidate cell ID. Alternatively, the CU 130 may obtain the CSI-Resource of candidate cells from the candidate DU 140, and generalizes the CSI-ResourceConfig including the CSI-Resource of candidate cells and the corresponding candidate cell ID, and then the source DU 110 obtains the CSI-ResourceConfig of candidate cells and the corresponding candidate cell ID from the CU 130.

By configuring the CSI resource associated with the candidate cells, since each CSI resource in the CSI resource configuration corresponds to a respective candidate cell and the source DU 110 is aware of the CSI resource configuration, when the source DU 110 receives the CSI resource measurement report, the measurement for a respective CSI resource can be determined by the source DU 110 to be associated with a specific candidate cell, that is to say, the source DU 110 may determine the target cell ID based on the L1 measurement report. Therefore, the L1 measurement for the CSI resource set may support L1 measurement-based LTM, the source DU 110 may determine the target cell from the candidate cells based on the CRI or SSBRI of L1 measurement report.

Hereinafter, the scenario in which the CSI resource configuration is generalized by a candidate DU 140 will be described.

When the first network device 130 obtains the CSI resource set, it may also obtain a CSI resource configuration set from the candidate DU 140 and then transmit the information 201 to the second network device 110, and then to the terminal device 120. Since the L1 measurement is reported to the source DU 110, rather than the candidate DU 140, there may be a need for the report configuration for the candidate cells, such that the source DU 110 may receive from the UE 120 the L1 measurement for the CSI resource set configured by the candidate DU 140, and such that the source DU 110 may further know the specific cell identity with which the measurement is associated.

Therefore, in some embodiments, the CSI resource set associated with the candidate cells 141 to 144 may be comprised in a candidate cell configuration set, and each candidate cell configuration may comprise a CSI resource configuration set for the one or more candidate cells, and a CSI report configuration set for the one or more candidate cells.

For the candidate cell configuration, it is the configuration for each candidate cell 141, 142, 143, or 144 at the candidate DU 140 used for LTM, which includes the cell ID of the candidate cell. Each candidate cell has one candidate cell configuration. There may be one or more candidate cell configurations at the same candidate DU 140 for the UE 120, or more candidate cell configurations at the different candidate DUs 140 for the UE 120. Each candidate cell configuration is identified by an index, called as candidate cell configuration index, candidate configuration index, or other names.

For the CSI-Reportconfig, it may be used to configure a L1 measurement report sent on physical uplink control channel (PUCCH) on the cell in which the CSI-ReportConfig is included, or to configure a L1 measurement report sent on physical uplink shared channel (PUSCH) on the cell in which the CSI-ReportConfig is included. The CSI-ReportConfig includes the CSI-Resource for channel measurement, report quantity indicating the CSI related quantities (e.g., CRI-RSRP, SSB-Index-RSRP) to report, the PUCCH to send the L1 measurement report, etc.

For example, the candidate DU 140 generalizes the CSI-MeasConfig for each candidate cell, where the CSI-MeasConfig includes the CSI-ResourceConfig and CSI-ReportConfig. In one example, the CSI-MeasConfig for the candidate cell is provided under the CellGroupConfig of the candidate cell. The CU 130 sends the CSI-ReportConfig of the serving cell to the candidate DU 140, based on which the candidate DU 140 will generalize the CSI-ResourceConfig of the candidate cell. For example, the L1 measurement report sent by UE includes the candidate cell ID which indicates the target cell where the L1 measurement instance is related to. For example, the candidate cell ID will be the PCI, or candidate configuration index, where each index is used to identify a candidate cell configuration.

In these embodiments, by configuring the report configuration for the candidate DU 140, even the CSI resource set is configured by the candidate DU 140, the source DU 110 may receive the measurement report from the UE 120 through the PUCCH or PUSCH indicated or configured by the report configuration for the candidate DU 140. Further, since the measurement report sent by UE 120 includes the candidate cell ID, and the candidate cell ID may indicate the target cell where the L1 measurement instance is related to, based on the L1 measurement report, the UE 120 may know the specific target cell ID based on the L1 measurement report.

Therefore, to support the L1 measurement when the configuration for L1 measurement reference signal is provided under CellGroupConfig for each candidate cell, the candidate DU 140 generalizes the CSI-MeasConfig for each candidate cell, where the CSI-MeasConfig includes the CSI-ResourceConfig and CSI-ReportConfig (i.e., the CSI-MeasConfig for each candidate cell is provided by the candidate DU 140). The CU 130 may send the CSI-ReportConfig of the serving cell to the candidate DU 140, based on which the candidate DU 140 will generalize the CSI-ResourceConfig of the candidate cell. Further, The L1 measurement report sent by UE may include the candidate cell identity which indicates the target cell where the L1 measurement instance is related to.

Hereinafter, how the candidate DU 140 to determine the CSI resource that is compatible with the UE capability of LTM L1 measurement will be described.

The CSI-Resource of candidate cells is provided by the candidate DU 140. The candidate cells will be within the same candidate DU 140 or different candidate DUs 140. If the candidate DU 140 provides the CSI-Resource for each candidate cell without limited number, the CSI-ResourceConfig for the UE will be too complex and the signaling overhead will be too large. For example, following the legacy CSI report framework, the maximum number of CSI-Resource sets per CSI-Resource configuration is 16, the maximum number of CSI-Resource per CSI-Resource set is 64, then the maximum number of CSI-Resource per cell is 1024. Considering the LTM, if there are 8 candidate cells, the final number of CSI-Resource for the UE will be 8192.

For example, in order to reduce the signaling overhead, the CU 130 may determine the maximum number of CSI-Resource to be provided for each candidate cell or each candidate DU 140, and send the maximum number to the candidate DU 140. Alternatively or additionally, the CU 130 may determine the number of CSI-Resource to be provided for each candidate cell or each candidate DU 140, and send the number to the candidate DU 140.

For example, if the candidate DU 140 receives the maximum number of CSI-Resource to be provided for each candidate cell from the CU 130, the candidate DU 140 will prepare the CSI-Resource for each candidate cell no more than the maximum number accordingly.

For example, if the candidate DU 140 receives the maximum number of CSI-Resource to be provided for each candidate DU 140 (i.e., the maximum number of CSI-Resource is for all the candidate cells within the same candidate DU 140), the candidate DU 140 will determine the maximum number of CSI-Resource for each candidate cell.

For example, the CU 130 may obtain the UE capability of LTM L1 measurement first, and then the CU 130 may determine the above-mentioned number for CSI resource or other parameters, and send these parameters to the candidate DU 140, and then the candidate DU 140 may configure the CSI resource for each candidate cell based on these parameters.

The UE capability may include at least one of the following: (1) an indicator indicates whether the UE supports for the CSI-RS based L1 measurement on candidate cell; (2) an indicator indicates whether the UE supports for the SSB based L1 measurement on candidate cell; (3) an indicator indicates whether the UE supports the configuration for L1 measurement reference signal of candidate cell is provided under the ServingCellConfig for the serving cell (that is to say, the CSI-ResourceConfig includes the CSI-Resource of both serving cell and candidate cells under the ServingCellConfig for the serving cell); (4) an indicator indicates whether the UE supports the configuration for L1 measurement reference signal of candidate cell is provided separately from ServingCellConfig for the serving cell and CellGroupConfig for the candidate cell; (5) an indicator indicates whether the UE supports the configuration for L1 measurement reference signal of candidate cell is provided under CellGroupConfig for the candidate cell, where each candidate cell has its own CellGroupConfig; (6) the maximum total number of configured CSI-RS (e.g., NZP (Non-Zero-power)-CSI-RS) resources and SSBs that are supported by the UE to perform L1 measurement, e.g., to measure L1-RSRP (Reference Signal Received Power), in which the maximum total number of configured CSI-RS and SSBs is for the group of candidate cells, for each candidate cell, or for the group of serving cell and candidate cells; (7) the maximum total number of configured CSI-RS (e.g., NZP-CSI-RS) resources that are supported by the UE to perform L1 measurement, e.g., to measure L1-RSRP, in which the maximum total number of configured CSI-RS resources is for the group of candidate cell, for each candidate cell, or for the group of serving cell and candidate cells; (8) the maximum number of periodic or aperiodic or semi-persistent CSI report setting per BWP (Bandwidth Part) for CSI report or beam report; or (9) the number of CSI reports for which the UE can measure and process reference signals simultaneously (the CSI report comprises periodic, aperiodic and semi-persistent CSI. The CSI report includes the beam report and CSI report).

It should be noted that the above listed parameters are just exemplary embodiments of the UE capability, and the present disclosure is not limited thereto in any way.

By obtaining the UE capacity first, the CU 130 may determine suitable parameters for the candidate DU 140 to configure the CSI resource for L1 measurements, thereby reducing the signalling overhead.

Therefore, in order to reduce the signalling overhead and UE capacity, the number of CSI-Resource for candidate cells should be limited. For example, the CU 130 may obtain the UE capability of LTM L1 measurement for performing L1 measurement, and then at least based on the UE capability, the CU 130 may determine the maximum number of CSI-Resource to be provided for each candidate cell or each candidate DU 140, and sends the number to the candidate DU 140.

### Exemplary Message Flow

Hereinafter, the message flow 300 of a communication process in accordance with some example embodiments of the present disclosure will be described with reference to FIG. 3. In this embodiment, the source DU 110 obtains the CSI-Resource and the corresponding candidate cell ID from the CU 130. After that, the source DU 110 generalizes the CSI-ResourceConfig including the CSI-Resource of candidate cells 141 to 144 and the corresponding candidate cell ID, where the CSI-ResourceConfig will be sent to the UE 120 via the CU 130.

As shown in FIG. 3, at step 1, the CU 130 sends the UE Capability Enquiry to the source DU 110 when the CU 130 needs the UE L1 measurement capability information.

In one example, an indicator is included in the UE Capability Enquiry which indicates the UE L1 measurement capability. The UE L1 measurement capability is the UE capability of L1 measurement on the candidate cell. It will be named as UE LTM L1 measurement capability, UE LTM capability, etc.

In another example, the UE L1 measurement capability may further include the L1 measurement capability filter. The L1 measurement capability filter is the information by which the CU 130 requests the UE 120 to filter the UE capabilities. The L1 measurement capability filter includes at least one of the following: (a) Measurement type, which indicates the L1 measurement type, e.g., CSI-RS based L1 measurement, SSB based L1 measurement; (b) Configuration type, which indicates the type of configuration for L1 measurement reference signal of the candidate cell, e.g., under the ServingCellConfig for the serving cell, separately from ServingCellConfig for the serving cell and CellGroupConfig for the candidate cell, under CellGroupConfig for the candidate cell; (c) maximum total number of configured CSI-RS resources and SSBs that are supported by the UE to perform L1 measurement; (d) maximum total number of configured CSI-RS resources that are supported by the UE to perform L1 measurement; (e) maximum number of periodic or aperiodic or semi-persistent CSI report setting per BWP for CSI report or beam report; and (f) number of CSI reports for which the UE can measure and process reference signals simultaneously. The CSI report comprises periodic, aperiodic and semi-persistent CSI. The CSI report includes the beam report and CSI report.

In another example, the UE Capability Enquiry is included in the DL RRC MESSAGE TRANSFER message.

As shown in FIG. 3, at step 2, the source DU 110 forwards the received UE Capability Enquiry to the UE 120. At step 3, the UE 120 sends the UE Capability Information to the source DU 110, to report the UE L1 measurement capability information.

In one example, the UE L1 measurement capability information is included in the UE Capability Information. The UE L1 measurement capability information includes the following information: 1) an indicator indicates whether the UE supports for the CSI-RS based L1 measurement on candidate cell; 2) an indicator indicates whether the UE supports for the SSB based L1 measurement on candidate cell; 3) an indicator indicates whether the UE supports the configuration for L1 measurement reference signal of candidate cell is provided under the ServingCellConfig for the serving cell (That is, the final CSI-ResourceConfig includes the CSI-Resource of both serving cell and candidate cells under the ServingCellConfig for the serving cell); 4) an indicator indicates whether the UE supports the configuration for L1 measurement reference signal of candidate cell is provided separately from ServingCellConfig for the serving cell and CellGroupConfig for the candidate cell; 5) an indicator indicates whether the UE supports the configuration for L1 measurement reference signal of candidate cell is provided under CellGroupConfig for the candidate cell; 6) maximum total number of configured CSI-RS resources and SSBs that are supported by the UE to perform L1 measurement; 7) maximum total number of configured CSI-RS resources that are supported by the UE to perform L1 measurement; 8) maximum number of periodic or aperiodic or semi-persistent CSI report setting per BWP for CSI report or beam report; and 9) number of CSI reports for which the UE can measure and process reference signals simultaneously. The CSI report comprises periodic, aperiodic and semi-persistent CSI. The CSI report includes the beam report and CSI report.

In another example, the UE L1 measurement capability information includes one or more of the above information (1) to (9) if the L1 measurement capability filter is not included in the received UE Capability Enquiry. In another example, the UE L1 measurement capability information includes one or more of the above information (1) to (9) corresponding to the L1 measurement capability filter included in the received UE Capability Enquiry. For example, if the Configuration type is included in the L1 measurement capability filter, the UE 120 will report the type of configuration for L1 measurement reference signal of the candidate cell that the UE supports, e.g., under the ServingCellConfig for the serving cell. In another example, the UE Capability Information is included in the UL RRC MESSAGE TRANSFER message.

As shown in FIG. 3, at step 4, the source DU 110 forwards the received UE Capability Information to the CU 130. It should be noted that the step 1~4 is optional. If the CU 130 has the UE L1 measurement capability information, the step 1~4 is not needed.

As shown in FIG. 3, at step 5, the CU 130 determines the number of CSI-Resource or the maximum number of CSI-Resource to be provided for each candidate cell or each candidate DU 140.

In one example, the CU 130 determines the number of CSI-Resource for each candidate cell, for example, cell 141, 142, 143, or 144. Accordingly, the candidate DU 140 should prepare the CSI-Resource for the candidate cell 141, 142, 143, or 144. It should be noted that the number of CSI-Resource for one candidate cell may be different from the number of CSI-Resource for another candidate cell.

In another example, the CU 130 determines the maximum number of CSI-Resource for each candidate cell. Accordingly, the candidate DU 140 should prepare the CSI-Resource for the candidate cell no more than the maximum number. It should be note that the maximum number of CSI-Resource for one candidate cell may be different from the maximum number of CSI-Resource for another candidate cell.

In another example, the CU 130 determines the number of CSI-Resource for each candidate DU 140. Accordingly, the candidate DU 140 should prepare the CSI-Resource for each candidate cell (for example, cell 141, 142, 143, or 144) belonging to the candidate DU 140, and the total number of CSI-Resource for candidate cells belonging to the candidate DU should be equal to the number of CSI-Resource for the candidate DU. It should be noted that the number of CSI-Resource for one candidate DU may be different from the number of CSI-Resource for another candidate DU.

In another example, the CU 130 determines the maximum number of CSI-Resource for each candidate DU 140. Accordingly, the candidate DU 140 should prepare the CSI-Resource for each candidate cell belonging to the candidate DU, and the total number of CSI-Resource for candidate cells belonging to the candidate DU should be no more than the maximum number. It should be noted that the maximum number of CSI-Resource for one candidate DU may be different from the maximum number of CSI-Resource for another candidate DU.

In another example, based on the UE L1 measurement capability information, the CU 130 determines the number of CSI-Resource or the maximum number of CSI-Resource to be provided for each candidate cell or each candidate DU 140. In another example, the number of CSI-Resource or the maximum number of CSI-Resource to be provided for each candidate cell or each candidate DU 140 is up to the CU implementation, e.g., based on the historical L1 measurement results.

As shown in FIG. 3, at step 6, the CU 130 requests the preparation of candidate cells in the candidate DU(s) 140 by sending UE CONTEXT SETUP REQUEST message including the candidate cell ID(s) to the candidate DU(s) 140 to create a UE context and setup one or more data bearers. It should be noted that the candidate cells belong to the same candidate DU, or different candidate DUs. The candidate cell ID may be the PCI and/or CGI of the candidate cell. The UE CONTEXT SETUP REQUEST message may further include the number of CSI-Resource or the maximum number of CSI-Resource to be provided for each candidate cell or each candidate DU. In one example, the number of CSI-Resource or the maximum number of CSI-Resource to be provided for each candidate cell or each candidate DU is included in the CU to DU RRC Information IE in the UE CONTEXT SETUP REQUEST message.

In another example, the UE CONTEXT SETUP REQUEST message is sent for each candidate cell. That is, the CU 130 sends multiple UE CONTEXT SETUP REQUEST messages, where each UE CONTEXT SETUP REQUEST message includes a candidate cell ID. The UE CONTEXT SETUP REQUEST message may further include the number of CSI-Resource or the maximum number of CSI-Resource to be provided for the candidate cell.

In another example, the UE CONTEXT SETUP REQUEST message includes multiple candidate cell IDs (e.g., a list of candidate cell IDs) to the candidate DU where the multiple candidate cells are within the same candidate DU. The UE CONTEXT SETUP REQUEST message may further include the number of CSI-Resource or the maximum number of CSI-Resource to be provided for each candidate cell or for the candidate DU.

As shown in FIG. 3, at step 7, if the preparation request is accepted, the candidate DU 140 responds to the CU 130 with a UE CONTEXT SETUP RESPONSE message. The UE CONTEXT SETUP RESPONSE message includes the candidate cell ID(s) that was requested from the CU, as well as the candidate cell configurations. In one example, the candidate cell configuration includes the lower layer configuration for the candidate cell, e.g., CellGroupConfig, which contains the MAC entity, a set of logical channels with associated RLC entities, a primary cell and one or more secondary cells.

The UE CONTEXT SETUP RESPONSE message further includes the CSI-Resource for the candidate cell. The number of CSI-Resource for the candidate cell should be equal to the number of CSI-Resource for the candidate cell received in the UE CONTEXT SETUP REQUEST message, or no more than the maximum number of CSI-Resource for the candidate cell received in the UE CONTEXT SETUP REQUEST message. If the number of CSI-Resource or the maximum number of CSI-Resource is for the candidate DU received in the UE CONTEXT SETUP REQUEST message, the total number of the CSI-Resource for all candidate cells within the candidate DU should be equal to the number of CSI-Resource for the candidate DU, or no more than the maximum number of CSI-Resource for the candidate DU.

In one example, the CSI-Resource for the candidate cell is included in the DU to CU RRC Information IE in the UE CONTEXT SETUP RESPONSE message. In another example, the UE CONTEXT SETUP RESPONSE message is sent for each requested candidate cell. In another example, the UE CONTEXT SETUP RESPONSE message includes multiple candidate cell configurations, where each candidate cell configuration is for a candidate cell.

As shown in FIG. 3, at step 8, the CU 130 sends a UE CONTEXT MODIFICATION REQUEST message including the candidate cell configuration to the source DU 110 to modify UE context. The UE CONTEXT MODIFICATION REQUEST message includes the CSI-Resource for the candidate cell, which is received in the step 7. Each CSI-Resource should be related to a candidate cell ID, indicating the CSI-Resource is for which candidate cell. The candidate cell ID can be PCI, CGI or candidate configuration index, where each index is further used to identify a candidate cell configuration.

In one example, the CSI-Resource for the candidate cell is included in the CU to DU RRC Information IE in the UE CONTEXT MODIFICATION REQUEST message. In another example, the UE CONTEXT MODIFICATION REQUEST message is sent for each candidate cell. In another example, the UE CONTEXT MODIFICATION REQUEST message includes the CSI-Resource for multiple candidate cells.

As shown in FIG. 3, at step 9, if the request is accepted, the source DU 110 responds to the CU 130 with a UE CONTEXT MODIFICATION RESPONSE message. The UE CONTEXT MODIFICATION RESPONSE message includes the CSI-ResourceConfig for L1 measurement. The source DU 110 generalizes the CSI-ResourceConfig including the CSI-Resource of candidate cells, e.g., under the ServingCellConfig for serving cell. The CSI-ResourceConfig includes the CSI-Resource for the serving cell and the CSI-Resource for the candidate cell. Each CSI-Resource should be related to the serving cell ID or the candidate cell ID. For example, the CSI-ResourceConfig manner is provided as shown in FIG. 2B.

As shown in FIG. 2B, the CSI-resource #0 is the CSI resource for the serving cell (for example, cell 111 with PCI #0), the CSI-resource #1 is the CSI resource for the candidate cell (for example, cell 141 with PCI #1), the CSI-resource #2 is the CSI resource for the candidate cell (for example, cell 142 with PCI #2), and the CSI-resource #3 is the CSI resource for the candidate cell (for example, cell 143 with PCI #3). Since each CSI resource in the CSI resource configuration corresponds to a respective candidate cell and the source DU 110 is aware of the CSI resource configuration, when the source DU 110 receives the CSI resource measurement report, the measurement for a respective CSI resource can be determined by the source DU 110 to be associated with a specific candidate cell, that is to say, the source DU 110 may determine the target cell ID based on the L1 measurement report.

In one example, the CSI-ResourceConfig is included in the DU to CU RRC Information IE in the UE CONTEXT MODIFICATION RESPONSE message. In another example, the UE CONTEXT MODIFICATION RESPONSE message is sent for each requested candidate cell. In another example, the UE CONTEXT MODIFICATION RESPONSE message includes the CSI-ResourceConfig for the serving cell and multiple candidate cells.

As shown in FIG. 3, at step 10, the CU 130 sends a DL RRC MESSAGE TRANSFER message to the source DU 110, which includes a generated RRCReconfiguration message. The RRCReconfiguration message includes the CSI-ResourceConfig for the serving cell and one or more candidate cells. The RRCReconfiguration message may further include an indicator which indicates the UE 120 to maintain the CSI-ResourceConfig for the serving cell and one or more candidate cells after a cell switch. It should be noted that the CU 130 could send the RRCReconfiguration message to the source DU 110 via other message, e.g., UE CONTEXT MODIFICATION REQUEST message. It should be noted that the CU 130 could send the CSI-ResourceConfig for the serving cell and one or more candidate cells to the candidate DU 140 via UE CONTEXT MODIFICATION REQUEST message or other message, wherein the message may further include an indicator which indicates the candidate DU 140 to maintain the CSI-ResourceConfig for one or more candidate cells after a cell switch.

As shown in FIG. 3, at step 11, the source DU 110 forwards the RRCReconfiguration message to the UE 120. As shown in FIG. 3, at step 12, the UE 120 responds to the source DU 110 with a RRCReconfigurationComplete message. As shown in FIG. 3, at step 13, the source DU 110 forwards the RRCReconfigurationComplete message to the CU 130 via an UL RRC MESSAGE TRANSFER message. It should be noted that the source DU 110 could forward the RRCReconfigurationComplete message to the CU 130 via other message, e.g., UE CONTEXT MODIFICATION RESPONSE message.

As shown in FIG. 3, at step 14, the UE 120 starts to report the L1 measurements of candidate cells to the source DU 110. As shown in FIG. 3, at step 15, the source DU 110 determines that the LTM cell switch to a candidate cell is needed.

The L1 measurement report includes the SSBRI #k corresponding to the (k+1)-th entry of the associated CSI-SSB-ResourceList in the corresponding CSI-SSB-ResourceSet, or the CRI #k corresponding to the configured (k+1)-th entry of the associated NZP-CSI-RS-Resources in the corresponding NZP-CSI-RS-ResourceSet. Based on the CSI-ResourceConfig in step 9, the source DU 110 determines the candidate cell corresponding to the SSBRI #k or CRI #k.

As shown in FIG. 3, at step 16, the source DU 110 sends an LTM cell switch command (e.g., MAC CE) to the UE 120, to trigger the UE 120 to change from the current serving cell to the selected candidate cell. The LTM cell switch command (e.g., MAC CE) may further include an indicator which indicates the UE 120 to maintain the CSI-ResourceConfig for the serving cell and one or more candidate cells after a cell switch. As shown in FIG. 3, at step 17, an access procedure is performed between the UE 120 and the candidate DU 140.

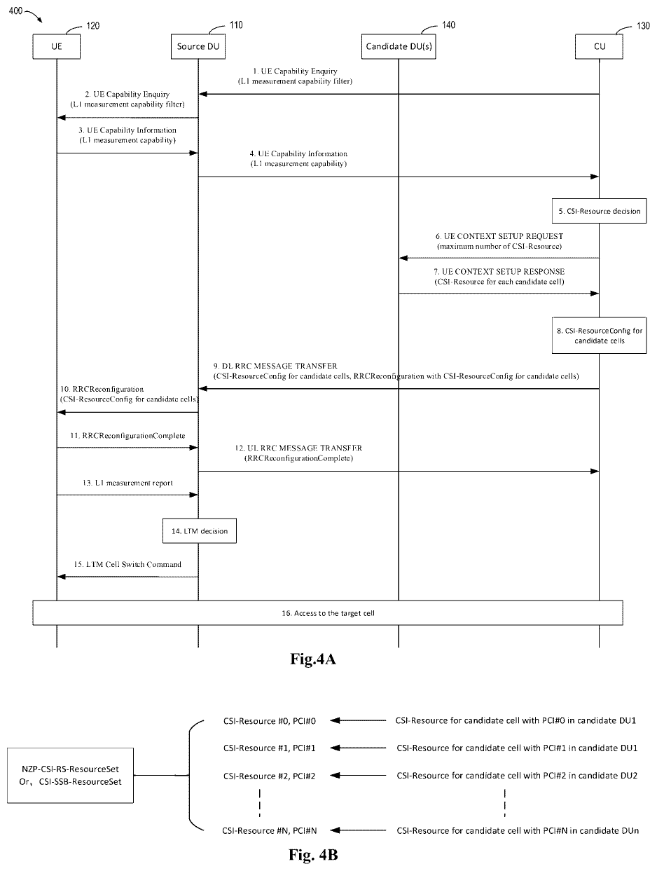

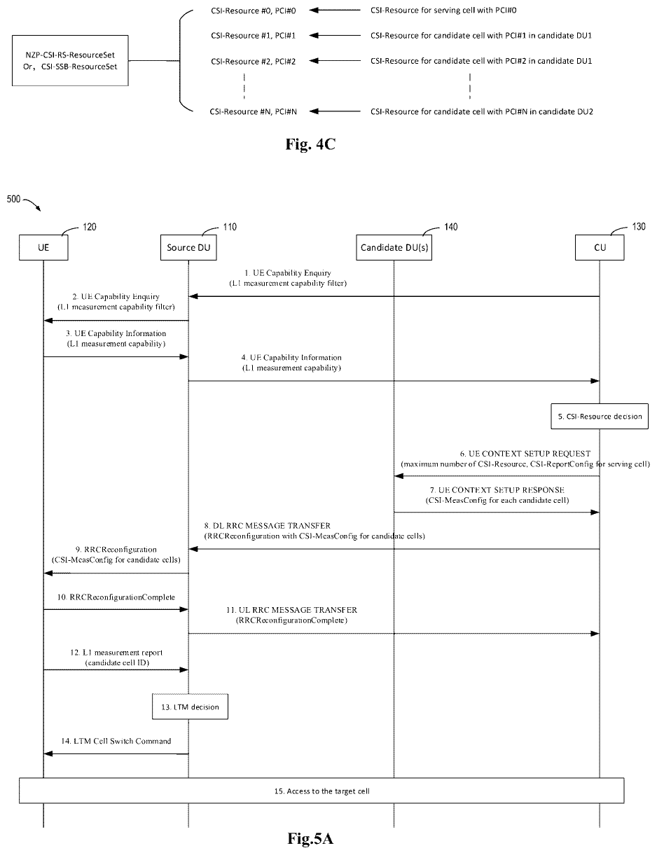

Hereinafter, the message flow 400 of a communication process in accordance with some example embodiments of the present disclosure will be described with reference to FIG. 4A. In this embodiment, the CU 130 obtains the CSI-Resource and the corresponding candidate cell ID from the candidate DU 140 and generalizes the CSI-ResourceConfig. The CU 130 then sends the final CSI-ResourceConfig to the UE 120. The CU 130 also sends the CSI-ResourceConfig to the source DU 110. The CSI-ResourceConfig includes the CSI-Resource of candidate cells and the corresponding candidate cell ID.

As shown in FIG. 4A, the steps 1 to 7 are substantially the same as those steps 1 to 7 as described with reference to FIG. 3, and thus the description for steps 1 to 7 of FIG. 4A will be omitted for brevity. It should be noted that the steps 1~4 are optional. If the CU 130 has the UE L1 measurement capability information, the steps 1~4 may not needed.

As shown in FIG. 4A, at step 8, the CU 130 generalizes the CSI-ResourceConfig including the CSI-Resource of candidate cells, e.g., separately from ServingCellConfig for the serving cells and CellGroupConfig for the candidate cells. Each CSI-Resource for the candidate cell should be related to the candidate cell ID, e.g., PCI, CGI or candidate configuration index.

In one example, the CSI-ResourceConfig manner is provided as shown in FIG. 4B. In another example, the CSI-ResourceConfig manner is provided as shown in FIG. 4C. In the example as shown in FIG. 4B, there is no CSI resource for serving cell, but in the example as shown in FIG. 4C, there is CSI resource for serving cell, such that the UE 120 may perform measurement for the CSI resource configured for serving cell. In the CSI resource configuration as shown in FIG. 4B and FIG. 4C, the CSI resource is configured for multiple candidate DUs, and even for a serving cell of a source DU 110.

As shown in FIG. 4A, at step 9, the CU 130 sends a DL RRC MESSAGE TRANSFER message to the source DU 110. The DL RRC MESSAGE TRANSFER message includes a generated RRCReconfiguration message. The RRCReconfiguration message includes the CSI-ResourceConfig for one or more candidate cells. The RRCReconfiguration message may further include an indicator which indicates the UE to maintain the CSI-ResourceConfig for one or more candidate cells after a cell switch. The DL RRC MESSAGE TRANSFER message further includes the CSI-ResourceConfig for one or more candidate cells, which is to be used by the source DU 110. The DL RRC MESSAGE TRANSFER message may further include an indicator which indicates the source DU 110 to maintain the CSI-ResourceConfig for one or more candidate cells after a cell switch. It should be noted that the CU could send the RRCReconfiguration message and the CSI-ResourceConfig for candidate cells to the source DU 110 via other message, e.g., UE CONTEXT MODIFICATION REQUEST message. It should be noted that the CU 130 could send the CSI-ResourceConfig for one or more candidate cells to the candidate DU 140 via UE CONTEXT MODIFICATION REQUEST message or other message, wherein the message may further include an indicator which indicates the candidate DU 140 to maintain the CSI-ResourceConfig for one or more candidate cells after a cell switch.

As shown in FIG. 4A, at step 10, the source DU 110 stores the CSI-ResourceConfig for candidate cells and forwards the RRCReconfiguration message to the UE 120.

As shown in FIG. 4A, the steps 11 to 16 are substantially the same as those steps 12 to 17 as described with reference to FIG. 3, and thus the description for steps 11 to 16 of FIG. 4A will be omitted for brevity.

Hereinafter, the message flow 500 of a communication process in accordance with some example embodiments of the present disclosure will be described with reference to FIG. 5A. In this embodiment, the candidate DU 140 generalizes the CSI-MeasConfig for each candidate cell, where the CSI-MeasConfig includes the CSI-ResourceConfig and CSI-ReportConfig.

As shown in FIG. 5A, the steps 1 to 5 are substantially the same as those steps 1 to 5 as described with reference to FIG. 3, and thus the description for steps 1 to 5 of FIG. 5A will be omitted for brevity. It should be noted that the steps 1~4 are optional. If the CU 130 has the UE L1 measurement capability information, the steps 1~4 may not needed.

As shown in FIG. 5A, at step 6, the CU 130 requests the preparation of candidate cells in the candidate DU(s) by sending UE CONTEXT SETUP REQUEST message including the candidate cell IDs to the candidate DU(s) 140 to create a UE context and setup one or more data bearers. Note that the candidate cells are in the same candidate DU, or different candidate DUs. The candidate cell ID may be the PCI and/or CGI of the candidate cell.

The UE CONTEXT SETUP REQUEST message includes the CSI-ReportConfig for serving cell. The CSI-ReportConfig includes at least one of the following: (1) Report quantity: indicates the CSI related quantities to report, e.g., CRI-RSRP, SSB-Index-RSRP; and (2) PUCCH-CSI-Resource: indicates the resource to send the L1 measurement report when the L1 measurement report is sent on the serving cell.

The UE CONTEXT SETUP REQUEST message may further include the number of CSI-Resource or the maximum number of CSI-Resource to be provided for each candidate cell or each candidate DU. In one example, the number of CSI-Resource or the maximum number of CSI-Resource to be provided for each candidate cell or each candidate DU is included in the CU to DU RRC Information IE in the UE CONTEXT SETUP REQUEST message.

In another example, the UE CONTEXT SETUP REQUEST message is sent for each candidate cell. That is, the CU sends multiple UE CONTEXT SETUP REQUEST messages, where each UE CONTEXT SETUP REQUEST message includes a candidate cell ID. The UE CONTEXT SETUP REQUEST message may further include the number of CSI-Resource or the maximum number of CSI-Resource to be provided for the candidate cell.

In another example, the UE CONTEXT SETUP REQUEST message includes multiple candidate cell IDs (e.g., a list of candidate cell IDs) to the candidate DU where the multiple candidate cells are within the same candidate DU. The UE CONTEXT SETUP REQUEST message may further include the number of CSI-Resource or the maximum number of CSI-Resource to be provided for each candidate cell or for the candidate DU.

As shown in FIG. 5A, at step 7, if the preparation request is accepted, the candidate DU responds to the CU with a UE CONTEXT SETUP RESPONSE message. The UE CONTEXT SETUP RESPONSE message includes the candidate cell ID(s) that was requested from the CU, as well as the candidate cell configurations. The candidate cell configuration includes the lower layer configuration for the candidate cell, e.g., CellGroupConfig, which contains the MAC entity, a set of logical channels with associated RLC (Radio Link Control) entities, a primary cell and one or more secondary cells. The UE CONTEXT SETUP RESPONSE message further includes the CSI-MeasConfig for the candidate cell. The CSI-MeasConfig includes the CSI-ResourceConfig and CSI-ReportConfig for the candidate cell, where the CSI-ReportConfig is received in the step 6.

The number of CSI-Resource for the candidate cell should be equal to the number of CSI-Resource for the candidate cell received in the UE CONTEXT SETUP REQUEST message, or no more than the maximum number of CSI-Resource for the candidate cell received in the UE CONTEXT SETUP REQUEST message. If the number of CSI-Resource or the maximum number of CSI-Resource is for the candidate DU received in the UE CONTEXT SETUP REQUEST message, the total number of the CSI-Resource for all candidate cells within the candidate DU should be equal to the number of CSI-Resource for the candidate DU, or no more than the maximum number of CSI-Resource for the candidate DU.

For example, the CSI-MeasConfig manner is provided as shown in FIG. 5B. As shown in FIG. 5B, the CSI resource is configured for each candidate cell within the candidate DU 1, for example, one candidate DU 140. There is no CSI resource configured for another candidate DU. That is to say, the CSI resource is configured for the cell group in one candidate DU.

In one example, as shown in FIG. 5B, the CSI-MeasConfig for the candidate cell is provided under the CellGroupConfig of the candidate cell. In another example, the UE CONTEXT SETUP RESPONSE message is sent for each requested candidate cell. In another example, the UE CONTEXT SETUP RESPONSE message includes multiple candidate cell configurations, where each candidate cell configuration is for a candidate cell.

As shown in FIG. 5A, at step 8, the CU 130 sends a DL RRC MESSAGE TRANSFER message to the source DU 110, which includes a generated RRCReconfiguration message. The RRCReconfiguration message includes one or more CSI-MeasConfig for the candidate cell(s). The RRCReconfiguration message may further include an indicator which indicates the UE to maintain the CSI-ResourceConfig for one or more candidate cells after a cell switch. Note that, the CU 130 could send the RRCReconfiguration message to the source DU 110 via other message, e.g., UE CONTEXT MODIFICATION REQUEST message.

As shown in FIG. 5A, the steps 9 to 11, 14 and 15 are substantially the same as those steps 11 to 13, 16 and 17 as described with reference to FIG. 3, and thus the description for steps 9 to 11, and 14 and 15 of FIG. 5A will be omitted for brevity.

As shown in FIG. 5A, at step 12, the UE 120 starts to report the L1 measurements of candidate cells to the source DU 110. The L1 measurement report sent by UE includes the candidate cell ID which indicates the candidate cell where the L1 measurement instance is related to. The candidate cell ID will be the PCI, or the candidate configuration index, where each index is used to identify a candidate cell configuration.

As shown in FIG. 5A, at step 13, the source DU 110 determines that the LTM cell switch to a candidate cell is needed. Since the L1 measurement report sent by UE includes the candidate cell ID, the source DU 110 determines which candidate cell should be selected as the target cell for LTM cell switch based on the L1 measurement report.

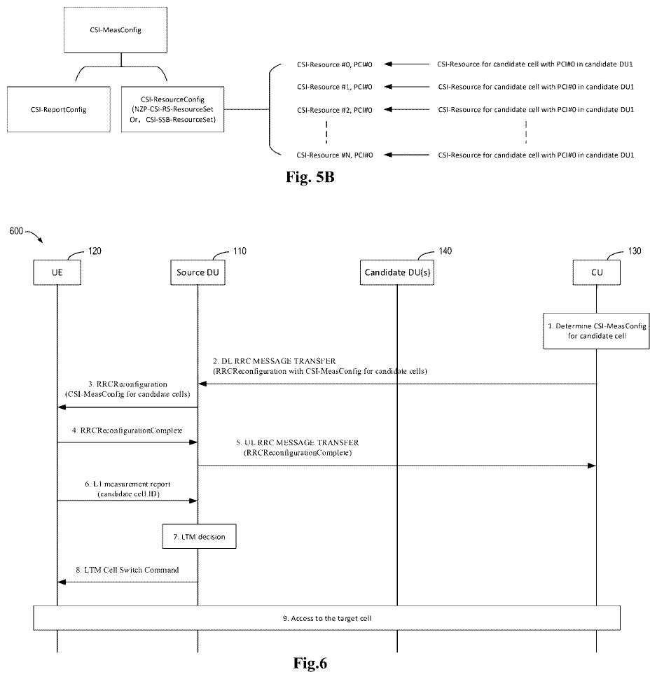

Hereinafter, the message flow 600 of a communication process in accordance with some example embodiments of the present disclosure will be described with reference to FIG. 6. In this embodiment, the L1 measurement report sent by UE 120 includes the candidate cell ID which indicates the candidate cell where the L1 measurement instance is related to. The candidate cell ID will be the PCI, or the candidate configuration index, where each index is used to identify a candidate cell configuration.

As shown in FIG. 6, at step 1, the CU 130 determines the CSI-MeasConfig for candidate cells. In one example, the CU obtains the CSI-MeasConfig for candidate cells as illustrated by FIG. 3. In this case, the CSI-MeasConfig includes the CSI-Resource for the serving cell and candidate cells. Each CSI-Resource for the candidate cell should be related to a candidate cell ID. Each CSI-Resource for the serving cell should be related to the serving cell ID.

In another example, the CU obtains the CSI-MeasConfig for candidate cells as illustrated by FIG. 4A. In this case, each CSI-Resource for the candidate cell should be related to a candidate cell ID.

In another example, the CU obtains the CSI-MeasConfig for candidate cells as illustrated by FIG. 5A. In this case, each CSI-Resource for the candidate cell should be related to a candidate cell ID.

As shown in FIG. 6, at step 2, the CU 130 sends a DL RRC MESSAGE TRANSFER message to the source DU 110, which includes a generated RRCReconfiguration message. The RRCReconfiguration message includes the CSI-MeasConfig for one or more candidate cells. The RRCReconfiguration message may further include an indicator which indicates the UE to maintain the CSI-ResourceConfig for one or more candidate cells after a cell switch. Note that, the CU could send the RRCReconfiguration message to the source DU 110 via other message, e.g., UE CONTEXT MODIFICATION REQUEST message. Note that, the CU 130 could send the CSI-ResourceConfig for one or more candidate cells to the candidate DU 140 via UE CONTEXT MODIFICATION REQUEST message or other message, wherein the message may further include an indicator which indicates the candidate DU 140 to maintain the CSI-ResourceConfig for one or more candidate cells after a cell switch.

As shown in FIG. 6, at step 3, the source DU 110 forwards the RRCReconfiguration message to the UE. As shown in FIG. 6, at step 4, the UE 120 responds to the source DU 110 with a RRCReconfigurationComplete message. As shown in FIG. 6, at step 5, the source DU 110 forwards the RRCReconfigurationComplete message to the CU via an UL RRC MESSAGE TRANSFER message. Note that, the source DU 110 could forward the RRCReconfigurationComplete message to the CU via other message, e.g., UE CONTEXT MODIFICATION RESPONSE message.

As shown in FIG. 6, at step 6, the UE 120 starts to report the L1 measurements of candidate cells to the source DU 110. The L1 measurement report sent by UE 120 includes the candidate cell ID which indicates the candidate cell where the L1 measurement instance is related to. The candidate cell ID will be the PCI, or the candidate configuration index, where each index is used to identify a candidate cell configuration.

As shown in FIG. 6, at step 7, the source DU 110 determines that the LTM cell switch to a candidate cell is needed. Since the L1 measurement report sent by UE includes the candidate cell ID, the source DU 110 determines which candidate cell should be selected as the target cell for LTM cell switch based on the L1 measurement report.

As shown in FIG. 6, at step 8, the source DU 110 sends an LTM cell switch command to the UE 120, to trigger the UE 120 to change from the current serving cell to the selected candidate cell. The LTM cell switch command (e.g., MAC CE) may further include an indicator which indicates the UE 120 to maintain the CSI-ResourceConfig for one or more candidate cells after a cell switch. As shown in FIG. 6, at step 9, an access procedure is performed between the UE 120 and the candidate DU 140.

### Example Methods

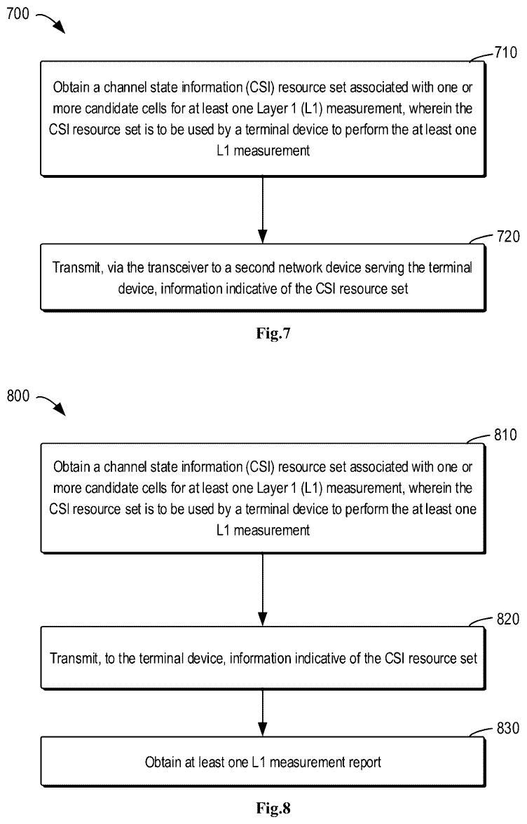

FIG. 7 illustrates a flowchart of an example method 700 for communication in accordance with some embodiments of the present disclosure. In some embodiments, the method 700 can be implemented at a device in a communication network, such as the first network device, a CU 130 as shown in FIG. 1C. Additionally or alternatively, the method 700 can be implemented at other devices shown in FIG. 1C. In some other embodiments, the method 700 may be implemented at devices not shown in FIG. 1C. Further, it is to be understood that the method 700 may include additional blocks not shown and/or may omit some blocks as shown, and the scope of the present disclosure is not limited in this regard. For the purpose of discussion, the method 700 will be described from the perspective of the first network device 130 with reference to FIG. 1C.

At block 710, the first network device 130 obtains a CSI resource set associated with one or more candidate cells 141 to 144 for at least one L1 measurement, wherein the CSI resource set is to be used by a terminal device 120 to perform the at least one L1 measurement. At block 720, the first network device 130 transmit, via the transceiver to a second network device 110 serving the terminal device 120, information indicative of the CSI resource set.

In some embodiments, the first network device 130 determines, based on the obtained CSI resource set, a CSI resource configuration set comprising the CSI resource set and one or more corresponding identities of the one or more candidate cells, and then transmits the CSI resource configuration set indicative of the CSI resource set to the second network device 110. In some embodiments, the first network device 130 receives from the second network device 110, a CSI resource configuration set comprising the CSI resource set and one or more corresponding identities of the one or more candidate cells, wherein the CSI resource configuration set is determined by the second network device 110 based on received CSI resource set.

In some embodiments, the first network device 130 receives from the one or more candidate cells provided by a third network device 140, a candidate cell configuration set indicative the CSI resource set for the one or more candidate cells. In some embodiments, the candidate cell configuration set comprises: a CSI resource configuration set for the one or more candidate cells, and a CSI report configuration set for the one or more candidate cells. In some embodiments, the first network device 130 further transmit, to the third network device 140, a CSI report configuration for the second network device, wherein the CSI report configuration set for the one or more candidate cells is determined based on the CSI report configuration for the second network device 110. In some embodiments, a CSI report configuration of the CSI report configuration set for the one or more candidate cells comprises one of the following: report quantity for indicating CSI-related quantities to report, or uplink transmission CSI resource for indicating a resource for transmitting a L1 measurement report to the second network device.

In some embodiments, the first network device 130 transmits, to the terminal device via the second network device, the CSI resource configuration set indicative of the CSI resource set. In some embodiments, the first network device 130 transmits, to the terminal device 120 via the second network device 110, the CSI report configuration set for the one or more candidate cells.

In some embodiments, the first network device 130 transmits, to the third network device, the CSI resource configuration set comprising the CSI resource set and one or more corresponding identities of the one or more candidate cells.

In some embodiments, the first network device 130 determines a maximum number of the CSI resource in the CSI resource set to be provided for a candidate cell among the one or more candidate cells provided by the third network device; and then transmits, to the third network device, the maximum number for determining the CSI resource set associated with the one or more candidate cells.

In some embodiments, the first network device 130 determines a number of the CSI resource in the CSI resource set to be provided for a candidate cell among the one or more candidate cells provided by the third network device; and then transmits, to the third network device, the number for determining the CSI resource set associated with the one or more candidate cells.

In some embodiments, the first network device 130 determines identities (IDs) of the one or more candidate cells; and transmits the IDs to the third network device for determining the CSI resource set associated with the one or more candidate cells.

In some embodiments, the identity of the candidate cell comprises: a PCI, a CGI, or candidate configuration indexes, wherein an index is used to identify a candidate configuration for a candidate cell.

In some embodiments, the first network device 130 obtains, from the terminal device, a L1 measurement capability of the terminal device. In some embodiments, the L1 measurement capability of the terminal device comprises one of the following: an indicator for indicating whether the terminal device supports for the CSI-RS-based L1 measurement on a candidate cell among the one or more candidate cells; an indicator for indicating whether the terminal device supports for the SSB-based L1 measurement on a candidate cell among the one or more candidate cells; an indicator for indicating whether the terminal device supports that a CSI resource configuration is also associated with the second network device; an indicator for indicating whether the terminal device supports the CSI resource configuration is provided separately for a serving cell or a candidate cell; an indicator for indicating whether the terminal device supports the CSI resource configuration is associated to a group of the one or more candidate cells; a maximum total number of configured CSI-RS resources and SSBs that are supported by terminal device to perform the L1 measurement; a maximum total number of configured CSI-RS resources that are supported by the terminal device to perform L1 measurement; a maximum number of periodic or aperiodic or semi-persistent CSI report setting per Bandwidth Part (BWP) for CSI report or beam report; or a number of CSI reports for which the terminal device is able to measure and process reference signals simultaneously.

In some embodiments, the first network device 130 transmits, to a third network device 140 providing one of the one or more candidate cells, one or more configurations indicative of the CSI resource set. In some embodiments, the first network device 130 transmits, to the terminal device 120 via the second network device 120, an indicator indicating the terminal device to maintain the CSI resource configuration set comprising the CSI resource set and one or more corresponding identities of the one or more candidate cells, after a cell switch.

FIG. 8 illustrates a flowchart of an example method 800 for communication in accordance with some embodiments of the present disclosure. In some embodiments, the method 800 can be implemented at a device in a communication network, such as the second network device, a source DU 110 as shown in FIG. 1C. Additionally or alternatively, the method 800 can be implemented at other devices shown in FIG. 1C. In some other embodiments, the method 800 may be implemented at devices not shown in FIG. 1C. Further, it is to be understood that the method 800 may include additional blocks not shown and/or may omit some blocks as shown, and the scope of the present disclosure is not limited in this regard. For the purpose of discussion, the method 800 will be described from the perspective of the second network device 110 with reference to FIG. 1C.

At block 810, the second network device 110 obtains a CSI resource set associated with one or more candidate cells for at least one L1 measurement, wherein the CSI resource set is to be used by a terminal device to perform the at least one L1 measurement. At block 820, the second network device 110 transmits, to the terminal device, information indicative of the CSI resource set. At block 830, the second network device 110 obtains at least one L1 measurement report.

In some embodiments, the at least one L1 measurement report is obtained from the terminal device 120. In some embodiments, the at least one L1 measurement report is obtained from a first network device 130.

In some embodiments, the CSI resource set is obtained from a first network device 130 for obtaining the CSI resource set from the one or more candidate cells 141 to 144; and the second network device 110 determines a CSI resource configuration set based on the obtained CSI resource set; and transmits, to the terminal device 120, the CSI resource configuration set indicative of the CSI resource set.

In some embodiments, the second network device 110 receives, from a first network device 130 for obtaining the CSI resource set associated with the one or more candidate cells, a CSI resource configuration set indicative of the CSI resource set; and transmits to the terminal device 120, the CSI resource configuration set indicative of the CSI resource set.

In some embodiments, the second network device selects a target cell from the one or more candidate cells based on the at least one L1 measurement report.

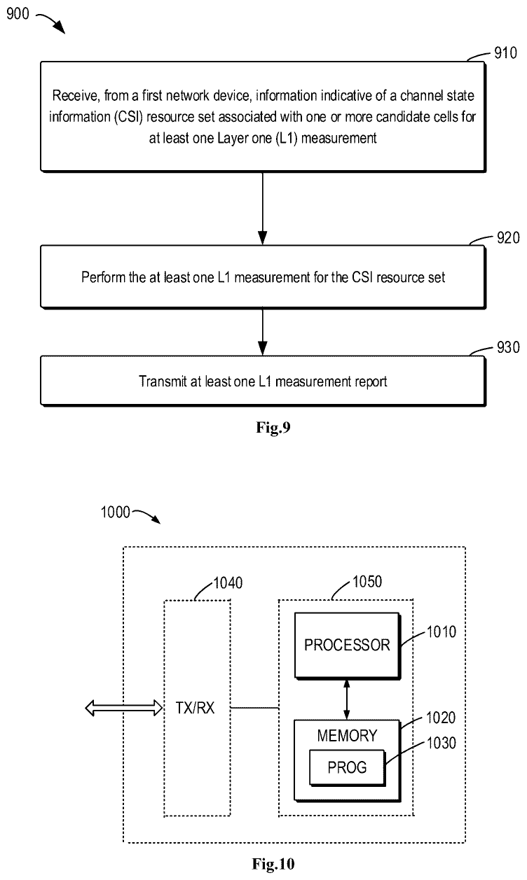

FIG. 9 illustrates a flowchart of an example method 900 for communication in accordance with some embodiments of the present disclosure. In some embodiments, the method 900 can be implemented at a device in a communication network, such as the terminal device 120 as shown in FIG. 1C. Additionally or alternatively, the method 900 can be implemented at other devices shown in FIG. 1C. In some other embodiments, the method 900 may be implemented at devices not shown in FIG. 1C. Further, it is to be understood that the method 900 may include additional blocks not shown and/or may omit some blocks as shown, and the scope of the present disclosure is not limited in this regard. For the purpose of discussion, the method 900 will be described from the perspective of the terminal device 120 with reference to FIG. 1C.

At block 910, the terminal device 120 receives, from a second network device 110, information indicative of a CSI resource set associated with one or more candidate cells 141 to 144 for at least oneL1measurement. At block 920, the terminal device 120 performs the at least one L1 measurement for the CSI resource set. At block 930, the terminal device 120 transmits at least one L1 measurement report.

In some embodiments, the terminal device 120 receives from the second network device 110, a CSI resource configuration set indicative of the CSI resource set; and transmits to the second network device 110, at least one L1 measurement result for the one or more candidate cells.

In some embodiments, the terminal device 120 receives from the second network device 110 an indicator indicating the terminal device to maintain the CSI resource configuration set comprising the CSI resource set and one or more corresponding identities of the one or more candidate cells, after a cell switch.

In some embodiments, the terminal device 120 receives, from the second network device 110, a CSI report configuration set for the one or more candidate cells, and a CSI resource configuration set indicative of the CSI resource set for the one or more candidate cells, and transmits to the second network device, at least one L1 measurement result for the one or more candidate cells and corresponding at least one identity of the one or more candidate cells.

In some embodiments, the at least one L1 measurement report is transmitted to a third network device 140 providing the one or more candidate cells.

### Example Apparatus

FIG. 10 illustrates a simplified block diagram of a device 1000 that is suitable for implementing embodiments of the present disclosure. The device 1000 can be considered as a further example implementation of the terminal device 120, and the network device 110, 130, and 140 as shown in FIG. 1C. Accordingly, the device 1000 can be implemented at or as at least a part of the terminal device 120, and the network device 110, 130, and 140.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a mobility management entity (MME)/serving gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 2-9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, an apparatus capable of performing the method 700 (for example, the first network device 130), method 800 (for example, a second network device 110), and method 900 (for example, a terminal device 120) may comprise means for performing the respective steps of the methods 700, 800, and 900. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of methods 700, 800, and 900.

The embodiments may further be described using the following clauses:

Clause 1. A first network device comprises: a processor; and a transceiver coupled to the processor, wherein the processor is configured to: obtain a channel state information (CSI) resource set associated with one or more candidate cells for at least one Layer 1 (L1) measurement, wherein the CSI resource set is to be used by a terminal device to perform the at least one L1 measurement; and transmit, via the transceiver to a second network device serving the terminal device, information indicative of the CSI resource set.

Clause 2. The first network device of clause 1, wherein the processor is further configured to: determine, based on the obtained CSI resource set, a CSI resource configuration set comprising the CSI resource set and one or more corresponding identities of the one or more candidate cells, and wherein transmitting, to the second network device, the information comprises: transmitting the CSI resource configuration set indicative of the CSI resource set to the second network device.

Clause 3. The first network device of clause 1, wherein the processor is further configured to: receive, from the second network device, a CSI resource configuration set comprising the CSI resource set and one or more corresponding identities of the one or more candidate cells, wherein the CSI resource configuration set is determined by the second network device based on received CSI resource set.

Clause 4. The first network device of clause 1, wherein obtaining the CSI resource set associated with the one or more candidate cells comprises: receiving, from the one or more candidate cells provided by a third network device, a candidate cell configuration set indicative the CSI resource set for the one or more candidate cells.

Clause 5. The first network device of clause 4, wherein the candidate cell configuration set comprises: a CSI resource configuration set for the one or more candidate cells, and a CSI report configuration set for the one or more candidate cells.

Clause 6. The first network device of clause 5, wherein the processor is further configured to: transmit, to the third network device, a CSI report configuration for the second network device, wherein the CSI report configuration set for the one or more candidate cells is determined based on the CSI report configuration for the second network device.

Clause 7. The first network device of clause 5 or 6, wherein a CSI report configuration of the CSI report configuration set for the one or more candidate cells comprises one of the following: report quantity for indicating CSI-related quantities to report, or uplink transmission CSI resource for indicating a resource for transmitting a L1 measurement report to the second network device.

Clause 8. The first network device of any of clauses 2, 3, and 5, wherein the first network device is further configured to: transmit, to the terminal device via the second network device, the CSI resource configuration set indicative of the CSI resource set.

Clause 9. The first network device of clause 5, wherein the processor is further configure to: transmit, to the terminal device via the second network device, the CSI report configuration set for the one or more candidate cells.

Clause 10. The first network device of any of clauses 1 to 9, wherein the processor is further configured to: determine a maximum number of the CSI resource in the CSI resource set to be provided for a candidate cell among the one or more candidate cells provided by the third network device; and transmit, to the third network device, the maximum number for determining the CSI resource set associated with the one or more candidate cells.

Clause 11. The first network device of any of clauses 1 to 9, wherein the processor is further configured to: determine a number of the CSI resource in the CSI resource set to be provided for a candidate cell among the one or more candidate cells provided by the third network device; and transmit, to the third network device, the number for determining the CSI resource set associated with the one or more candidate cells.

Clause 12. The first network device of any of clauses 1 to 11, wherein the processor is further configured to: determine identities (IDs) of the one or more candidate cells provided by a third network device; and transmit the IDs to the third network device for determining the CSI resource set associated with the one or more candidate cells.

Clause 13. The first network device of clause 12, wherein the identity of the candidate cell comprises: a physical cell identity (PCI), a cell global identity (CGI), or candidate configuration indexes, wherein an index is used to identify a candidate configuration for a candidate cell.

Clause 14. The first network device of any of clauses 1 to 13, wherein the processor is further configured to: obtain, from the terminal device, a L1 measurement capability of the terminal device.

Clause 15. The first network device of clause 14, wherein the L1 measurement capability of the terminal device comprises one of the following: an indicator for indicating whether the terminal device supports for the CSI-RS-based L1 measurement on a candidate cell among the one or more candidate cells; an indicator for indicating whether the terminal device supports for the synchronization signal block (SSB)-based L1 measurement on a candidate cell among the one or more candidate cells; an indicator for indicating whether the terminal device supports that a CSI resource configuration is also associated with the second network device; an indicator for indicating whether the terminal device supports the CSI resource configuration is provided separately for a serving cell or a candidate cell; an indicator for indicating whether the terminal device supports the CSI resource configuration is associated to a group of the one or more candidate cells; a maximum total number of configured CSI-RS resources and SSBs that are supported by terminal device to perform the L1 measurement; a maximum total number of configured CSI-RS resources that are supported by the terminal device to perform L1 measurement; a maximum number of periodic or aperiodic or semi-persistent CSI report setting per Bandwidth Part (BWP) for CSI report or beam report; or a number of CSI reports for which the terminal device is able to measure and process reference signals simultaneously.

Clause 16. The first network device of any of clauses 1 to 15, wherein the processor is further configured to: transmit, to a third network device providing one of the one or more candidate cells, one or more configurations indicative of the CSI resource set.

Clause 17. The first network device of any of clauses 1 to 16, wherein the first network device is further configured to: transmit, to the terminal device via the second network device, an indicator indicating the terminal device to maintain a CSI resource configuration set comprising the CSI resource set and one or more corresponding identities of the one or more candidate cells, after a cell switch.

Clause 18. A second network device comprises: a processor; and a transceiver coupled to the processor, wherein the processor is configured to: obtain a channel state information (CSI) resource set associated with one or more candidate cells for at least one Layer 1 (L1) measurement, wherein the CSI resource set is to be used by a terminal device to perform the at least one L1 measurement; transmit, to the terminal device, information indicative of the CSI resource set; and obtain at least one L1 measurement report.

Clause 19. The second network device of clause 18, wherein the at least one L1 measurement report is obtained from the terminal device.

Clause 20. The second network device of clause 18, wherein the at least one L1 measurement report is obtained from a first network device.

Clause 21. The second network device of any of clauses 18 to 20, wherein the CSI resource set is obtained from a first network device for obtaining the CSI resource set from the one or more candidate cells; and the second network device is further configured to: determine a CSI resource configuration set based on the obtained CSI resource set; wherein transmitting, to the terminal device, information indicative of the CSI resource set comprises: transmitting, to the terminal device, the CSI resource configuration set indicative of the CSI resource set.

Clause 22. The second network device of any of clauses 18 to 20, wherein obtaining the CSI resource set comprises: receiving, from a first network device for obtaining the CSI resource set associated with the one or more candidate cells, a CSI resource configuration set indicative of the CSI resource set; and wherein transmitting, to the terminal device, information indicative of the CSI resource set comprises: transmitting, to the terminal device, the CSI resource configuration set indicative of the CSI resource set.

Clause 23. The second network device of any of clause 18 to 22, wherein the second network device is further configured to: select a target cell from the one or more candidate cells based on the at least one L1 measurement report.

Clause 24. A terminal device comprising: a processor; and a transceiver coupled to the processor, wherein the processor is configured to: receive, from a second network device serving the terminal device, information indicative of a channel state information (CSI) resource set associated with one or more candidate cells for at least one Layer 1 (L1) measurement; perform the at least one L1 measurement for the CSI resource set; and transmit at least one L1 measurement report.

Clause 25. The terminal device of clause 24, wherein receiving, from the second network device, information indicative of the CSI resource set comprises: receiving, from the second network device, a CSI resource configuration set indicative of the CSI resource set; and wherein transmitting the at least one L1 measurement report comprises: transmitting, to the second network device, at least one L1 measurement result for the one or more candidate cells.

Clause 26. The terminal device of clause 24, wherein the terminal device is further configured to: receive, from the second network device, an indicator indicating the terminal device to maintain the CSI resource configuration set comprising the CSI resource set and one or more corresponding identities of the one or more candidate cells, after a cell switch.

Clause 27. The terminal device of clause 24, wherein receiving from the second network device, information indicative of the CSI resource set comprises: receiving, from the second network device, a CSI report configuration set for the one or more candidate cells, and a CSI resource configuration set indicative of the CSI resource set for the one or more candidate cells, and wherein transmitting the at least one L1 measurement report comprises: transmitting, to the second network device, at least one L1 measurement result for the one or more candidate cells and corresponding at least one identity of the one or more candidate cells.

Clause 28. The terminal device of clause 24, wherein the at least one L1 measurement report is transmitted to a third network device providing the one or more candidate cells.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first network device for wireless communication, comprising:
at least one memory; and
at least one processor coupled with the at least one memory and configured to cause the first network device to:
obtain a channel state information (CSI) resource set associated with one or more candidate cells for at least one Layer 1 (L1) measurement, wherein the CSI resource set is for a terminal device to perform the at least one L1 measurement; and
transmit, to a second network device serving the terminal device, information indicative of the CSI resource set.

2. The first network device of claim 1, wherein the at least one processor is further configured to cause the first network device to:
determine, based on the obtained CSI resource set, a CSI resource configuration set comprising the CSI resource set and one or more corresponding identities of the one or more candidate cells, and
wherein to transmit the information, the at least one processor is further configured to cause the first network device to transmit the CSI resource configuration set indicative of the CSI resource set to the second network device.

3. The first network device of claim 1, wherein the at least one processor is further configured to cause the first network device to:
receive, from the second network device, a CSI resource configuration set comprising the CSI resource set and one or more corresponding identities of the one or more candidate cells.

4. The first network device of claim 2, wherein the at least one processor is further configured to cause the first network device to:
transmit, to the terminal device via the second network device, the CSI resource configuration set indicative of the CSI resource set.

5. The first network device of claim 1, wherein the at least one processor is further configured to cause the first network device to:
determine a number of the CSI resources in the CSI resource set to be provided for a candidate cell among the one or more candidate cells provided by a third network device; and
transmit, to the third network device, the number for determining the CSI resource set associated with the one or more candidate cells.

6. The first network device of claim 1, wherein the at least one processor is further configured to cause the first network device to:
determine identities (IDs) of the one or more candidate cells provided by a third network device; and
transmit the IDs to the third network device for determining the CSI resource set associated with the one or more candidate cells.

7. The first network device of claim 6, wherein the identity of one of the one or more candidate cells comprises: a physical cell identity (PCI), a cell global identity (CGI), or candidate configuration indexes, wherein an index is used to identify a candidate cell configuration for a candidate cell.

8. The first network device of claim 1, wherein the at least one processor is further configured to cause the first network device to:
obtain, from the terminal device, a L1 measurement capability of the terminal device.

9. The first network device of claim 8, wherein the L1 measurement capability of the terminal device comprises one of:
an indicator for indicating whether the terminal device supports a channel state information reference signal (CSI-RS)-based L1 measurement on a candidate cell among the one or more candidate cells;
an indicator for indicating whether the terminal device supports a synchronization signal block (SSB)-based L1 measurement on the candidate cell among the one or more candidate cells;
an indicator for indicating whether the terminal device supports that a CSI resource configuration is also associated with the second network device;
an indicator for indicating whether the terminal device supports the CSI resource configuration is provided separately for a serving cell or a candidate cell;
an indicator for indicating whether the terminal device supports the CSI resource configuration is associated to a group of the one or more candidate cells;
a maximum total number of configured CSI-RS resources and SSBs that are supported by the terminal device to perform the L1 measurement;
a maximum total number of configured CSI-RS resources that are supported by the terminal device to perform the L1 measurement;
a maximum number of periodic or aperiodic or semi-persistent CSI report setting per Bandwidth Part (BWP) for CSI report or beam report; or
a number of CSI reports for which the terminal device is able to measure and process reference signals simultaneously.

10. The first network device of claim 1, wherein at least one processor is further configured to cause the first network device to:
transmit, to the terminal device via the second network device, an indicator indicating to the terminal device to maintain a CSI resource configuration set comprising the CSI resource set and one or more corresponding identities of the one or more candidate cells, after a cell switch.

11. A second network device for wireless communication, comprising:
at least one memory; and
at least one processor coupled with the at least one memory and configured to cause the second network device to:
obtain a channel state information (CSI) resource set associated with one or more candidate cells for at least one Layer 1 (L1) measurement, wherein the CSI resource set is for a terminal device to perform the at least one L1 measurement;
transmit, to the terminal device, information indicative of the CSI resource set; and
obtain at least one L1 measurement report.

12. The second network device of claim 11, wherein the CSI resource set is obtained from a first network device for obtaining the CSI resource set from the one or more candidate cells; and
the at least one processor is further configured to cause the second network device to:
determine a CSI resource configuration set based on the obtained CSI resource set;
wherein to transmit the information, the at least one processor is further configured to cause the second network device to transmit
the CSI resource configuration set indicative of the CSI resource set.

13. The second network device of claim 11, wherein to obtain the CSI resource set, the at least one processor is further configured to cause the second network device to:
receive, from a first network device for obtaining the CSI resource set associated with the one or more candidate cells, a CSI resource configuration set indicative of the CSI resource set; and
and wherein to transmit, to the terminal device, information indicative of the CSI resource set, the at least one processor is further configured to cause the second network device to transmit,
to the terminal device, the CSI resource configuration set indicative of the CSI resource set.

14. A terminal device for wireless communication, comprising:
at least one memory; and
at least one processor coupled with the at least one memory and configured to cause the terminal device to:
receive, from a second network device serving the terminal device, information indicative of a channel state information (CSI) resource set associated with one or more candidate cells for at least one Layer 1 (L1) measurement;
perform the at least one L1 measurement for the CSI resource set; and
transmit at least one L1 measurement report.

15. The terminal device of claim 14, wherein the at least one processor is further configured to cause the terminal device to:
receive, from the second network device, an indicator indicating to the terminal device to maintain a CSI resource configuration set comprising the CSI resource set and one or more corresponding identities of the one or more candidate cells, after a cell switch.

16. A method performed by a first network device, the method comprising:
obtaining a channel state information (CSI) resource set associated with one or more candidate cells for at least one Layer 1 (L1) measurement, wherein the CSI resource set is for a terminal device to perform the at least one L1 measurement; and
transmitting, to a second network device serving the terminal device, information indicative of the CSI resource set.

17. The method of claim 16, further comprising:
determining, based on the obtained CSI resource set, a CSI resource configuration set comprising the CSI resource set and one or more corresponding identities of the one or more candidate cells, and
wherein transmitting the information further comprises transmitting the CSI resource configuration set indicative of the CSI resource set to the second network device.

18. The method of claim 17, further comprising:
transmitting, to the terminal device via the second network device, the CSI resource configuration set indicative of the CSI resource set.

19. The method of claim 16, further comprising:
determining identities (IDs) of the one or more candidate cells provided by a third network device; and
transmitting the IDs to the third network device for determining the CSI resource set associated with the one or more candidate cells.

20. The method of claim 19, wherein the identity of one of the one or more candidate cells comprises: a physical cell identity (PCI), a cell global identity (CGI), or candidate configuration indexes, wherein an index is used to identify a candidate cell configuration for a candidate cell.
